(19) United States
(12) Patent Application Publication
(10) Pub. No.: US 2014/0144589 A1
(43) Pub. Date: May 29, 2014

(54) Apparatus, Methods, and Compositions for Producing Oriented Stretch Film In-Process

(71) Applicant: Paragon Films, Inc., Broken Arrow, OK (US)

(72) Inventors: Shaun Eugene Pirtle, Coweta, OK (US); Khurrum Shamsi, Tulsa, OK (US)

(73) Assignee: Paragon Films, Inc., Broken Arrow, OK (US)

(21) Appl. No.: 14/167,580

(22) Filed: Jan. 29, 2014

Related U.S. Application Data
(63) Continuation-in-part of application No. 12/470,207, filed on May 21, 2009, now abandoned.
(60) Provisional application No. 61/082,398, filed on Jul. 21, 2008.

(51) Int. Cl. B29C 53/00

(52) U.S. Cl. CPC B29C 53/005
USPC 156/461; 156/204

(57) ABSTRACT

Apparatus and methods for producing folded edges in a film in-process, and compositions of such film are provided. A method of folding edges includes: separating a first idler roll and a second idler roll by a first distance; positioning a plurality of folding guides between the first idler roll and the second idler roll; separating adjacent sections of film having a majority layer comprising a Ziegler Natta catalyzed linear low density polyethylene copolymer resin having molecules that inherently lack long chain branching, wherein a majority of said molecules are oriented in a substantially longitudinal direction due to an induced strain, and inducing two folds with each folding guide, thereby causing an edge of each section of film to turn under 180° and cling to a bottom surface of the section of film; and moving the adjacent sections of film from the folding guides to the second idler roll.

### STATEMENT OF RELATED CASES

The present application is a continuation-in-part of U.S. Non-Provisional patent application Ser. No. 12/470,207, filed on May 21, 2009, to which priority is hereby claimed; which claimed the benefit of U.S. Provisional Patent Application Ser. No. 61/082,398, filed on Jul. 21, 2008, the contents of which are hereby incorporated by reference in their entirety.

### FIELD OF THE INVENTION

The present invention relates generally to apparatus and methods for producing oriented stretch film in-process, and compositions of stretch film. In particular though non-limiting embodiments, the present invention relates to the use of selected resins to increase the level of orientation in the film as it is formed, thus eliminating the need to stretch the film in a separate step. In still further, non-limiting embodiments, the present invention relates to apparatus and methods for folding the edges of the oriented stretch film in-process, resulting in a film that is less susceptible to damage and easier to use.

### BACKGROUND OF THE INVENTION

Stretch films are widely used in a variety of bundling and packaging applications. For example, stretch films have become a common method of securing bulky loads such as boxes, merchandise, produce, equipment, parts, and other similar items on pallets. Stretch films are often stretched at the time of use, which requires the application of force in order to stretch the film as much as 200 percent to properly contain the load. In contrast, stretch films are sometimes “pre-stretched” by a film converter prior to delivery to the end-user. Pre-stretched films are described as films that are taken from master rolls of film that have already been produced, stretched in a separate step, and re-wound onto film rolls for later use. Many end-users have chosen to use pre-stretched films to increase the rate at which loads can be wrapped and to minimize the force required to wrap loads.

Pre-stretched films are typically made from various polyethylene resins and can be single or multilayer products. An additive known as a cling agent is frequently used to ensure that adjacent layers of film will cling to each other. A cling agent typically used in pre-stretched films is polybutene with a Saybolt Universal Viscosity of 3,000 SUS at 99° C. with an average molecular weight of 1,290. This cling agent requires time to migrate or “bloom” to the film's surface after the film is produced and typically starts to reach equilibrium in 12 to 24 hours under optimum storage conditions. If the film is stretched before the cling agent has fully migrated, the resulting film will have little or no appreciable cling. Films that are produced with excessive winding tension or stored at low temperatures will also have little or no cling due to the lack of migration of the cling agent.

As a result, conventional pre-stretched films require that master rolls of film be stored for several days before stretching in order for the cling agent to migrate and the cling to fully develop. This necessary delay between the time the film is produced and the time the film is stretched increases the cost and decreases the efficiency of making pre-stretched films.

After the cling has fully developed, pre-stretched films are stretched in a separate operation. This process orients the molecules in the film in a longitudinal direction, parallel to the direction of the film's travel through the stretching machine. This orientation in the machine direction removes most of the stretch in the film. The resulting film is relatively stiff for its thickness and has very little residual orientation or stretch remaining before the film fails in the machine direction. These characteristics are desirable because much less effort is required to secure a load using pre-stretched film as compared to conventional handheld stretch films.

However, this separate operation requires additional material handling, dedicated converting equipment, increased warehouse space, and the manpower needed to manage the operation. This process also results in increased film scrap and higher raw material usage, further increasing the cost and decreasing the efficiency of producing pre-stretched film.

As can be seen, there is a long-standing, but unmet need for methods, systems, and devices which can produce oriented stretch film in a single, continuous process. There is a further unmet need for improved compositions that can be used for producing stretch films, which do not require orientation or stretching in a separate step.

Another issue encountered with conventional stretch films is that the edges of the film are easily damaged, which results in tearing or failure of the film during use. Typically, the edges of the film are prepared by transversely slitting individual roll widths of film from a wider width of film by means of a conventional sharp edge slitter assembly. Any defects that are introduced into the edges of the film during the slitting process can result in film failure during the application process. Dropping the film roll or any other abuse during handling may also create zones of weakness or tears in the edges of the film.

One method of reinforcing the edges of the film is to fold the edges of the material to form a hem. For example, U.S. Pat. No. 5,565,222 discloses an apparatus for hemming the edges of stretch film. The apparatus consists of a first hemming roller with a width less than the width of the film, guide bars located adjacent to the film's path of travel, and a second hemming roller. As another example, U.S. Pat. No. 5,531,393 discloses a film with folded edges. Folding occurs before the film is stretched and is achieved by means of folding fingers that project inwardly from the side plates of the apparatus.

As can be seen, edge folds make the film easier to use and reduce waste by making the film less susceptible to failure due to tears, rough handling, or excessive stretching. However, current methods provide for edge folding in a separate and secondary process after the film has been produced, which increases the time and costs of film production. Thus, there is a long-standing, but unmet need for methods, systems, and devices which efficiently fold the edges of the film in-process.

### SUMMARY

Apparatus and methods for producing folded edges in a film in-process, and compositions of such film are provided. An apparatus for folding edges includes at least: a first idler roll; a second idler roll separated from the first idler roll by a first distance; and a plurality of folding guides that are positioned between the first idler roll and the second idler roll, wherein each folding guide separates adjacent sections of film and induces two folds, thereby causing an edge of each section of film to turn under 180° and cling to a bottom surface of the section of the film, as the film travels from the folding guides to the second idler roll; wherein the film comprises a majority layer comprising a Ziegler Natta catalyzed linear low density polyethylene (LLDPE) copolymer resin having molecules that inherently lack long chain branching, wherein a majority of said molecules are oriented in a substantially longitudinal direction due to an induced strain.

A method of folding edges includes at least: separating a first idler roll and a second idler roll by a first distance; positioning a plurality of folding guides between the first idler roll and the second idler roll; separating adjacent sections of film including at least a majority layer comprising a Ziegler Natta catalyzed linear low density polyethylene (LLDPE) copolymer resin having molecules that inherently lack long chain branching, wherein a majority of said molecules are oriented in a substantially longitudinal direction due to an induced strain, and inducing two folds in the film with each folding guide, thereby causing an edge of each section of film to turn under 180° and cling to a bottom surface of the section of film; and moving the adjacent sections of film from the folding guides to the second idler roll.

### BRIEF DESCRIPTION OF THE DRAWINGS

For a further understanding of the nature, objects and advantages of the present invention, reference should be had to the following descriptions read in conjunction with the following drawings:

FIG. 1 illustrates the steps for producing film in-process according to example embodiments disclosed herein; and

FIG. 2 illustrates an edge folding apparatus and folding assembly according to example embodiments disclosed herein.

### DETAILED DESCRIPTION

The following description is not to be taken in a limiting sense, but is made merely for the purpose of illustrating example embodiments.

According to example embodiments, apparatus for producing film in-process for use in the stretch film market are provided. According to further example embodiments, apparatus and methods are described for folding the edges of film in-process. According to still further example embodiments, the apparatus and methods allow for edge folds to be created on each side of a single section of film simultaneously. In still further example embodiments, multiple film rolls are folded simultaneously using the disclosed apparatus and methods. In alternative example embodiments, edge folds increase the ease of use of the film and reduce waste by making the film less susceptible to failure due to tears, rough handling, or excessive stretching.

In further example embodiments, particular resins and an angled die are used to increase the level of orientation in the film as it is formed, thus eliminating the need to stretch the film in a separate step.

In still further example embodiments, a cling agent is incorporated into the film, thus eliminating the storage time traditionally needed to develop the film's cling properties.

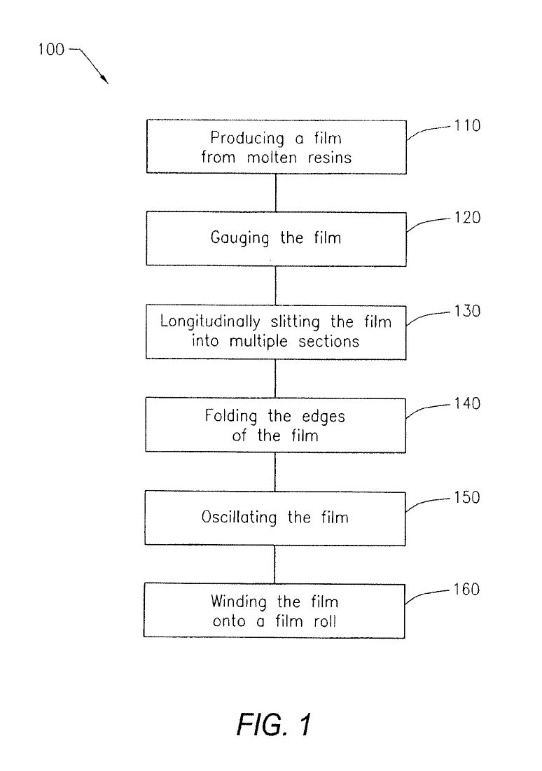

Turning to FIG. 1, the steps 100 for producing pre-stretched stretch film in-process, according to example embodiments, are illustrated. Specifically, according to example embodiments, the steps comprise producing a film from molten resins 110, gauging the film 120, longitudinally slitting the film into multiple sections 130, folding the edges of the film 140, oscillating the film 150, and winding the film onto a film roll 160 in a manner that prevents stacking of the edge folds and entraps air between the layers of film. In still other example embodiments, all of the steps are performed in-process along a single production line. In still further example embodiments, the steps are performed in a different order, and in still other example embodiments, one or more steps are eliminated without departing from the scope of the present disclosure.

Slitting assemblies are well-known in the art, and according to example embodiments, any conventional slitting assembly is used to slit the film into multiple sections. According to further example embodiments, an interior slit is defined as a slit made somewhere within the original width of film, resulting in multiple sections of lesser width. According to still further example embodiments, each interior slit requires only one folding guide assembly to accommodate both adjacent film edges. In still further example embodiments, an exterior slit is defined as a slit made along one of the edges of the original width of film. In alternative example embodiments, each exterior edge requires a separate folding guide assembly.

As shown in FIG. 1, according to other example embodiments, the edges of the film are folded after the film is longitudinally slit into multiple sections. In other example embodiments, the edge folds make the film less susceptible to failure due to tears, rough handling, dropping, or excessive stretching. Thus, in still further example embodiments, the ability to introduce and maintain edge folds improves film performance.

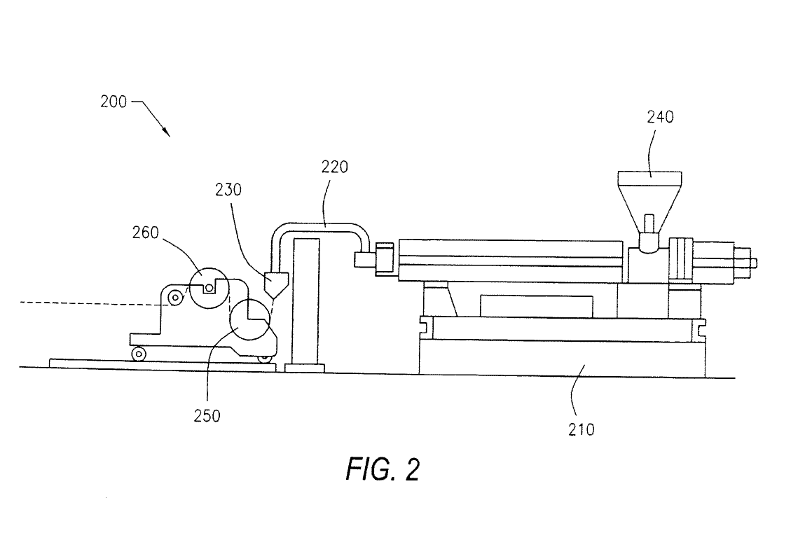

Turning next to FIG. 2, according to example embodiments, a system for folding the edges of the film 210 comprises a first idler roll 220, a second idler roll 230, and a folding guide assembly 235, placed between the first idler roll 220 and the second idler roll 230. In alternative example embodiments, the folding guide assembly 235 is comprised of a plurality of folding guides 240-245, which are placed in the slits 270 between sections of film 210 to separate the sections of film 210. As shown in FIG. 2, the folding guides 240-245 are folding rods according to certain example embodiments, but other types of folding guides are also contemplated herein.

According to other example embodiments, after the sections of film 210 are separated, the cling agent and the tension of the film 210 cause the edge folds 250 to form spontaneously. In other example embodiments, each folding guide 240 separates adjacent sections of film 210 and induces two folds 250, thereby causing an edge of each section of film to turn under 180° and cling to a bottom surface of the section of film.

In other example embodiments, each interior folding rod 240 produces two edge folds 250, while each exterior folding rod 245 produces one edge fold 250.

According to further example embodiments, each folding guide 240-245 is comprised of steel, aluminum, nylon, or any other material of sufficient modulus to be able to maintain rigidity. According to still further example embodiments, each folding guide also has a coefficient of friction that allows the edge of the film to turn back on itself, thus introducing a fold. In still further example embodiments, the diameter and placement of the folding guides 240-245 assist in achieving and maintaining edge folds 250 without roping or wrinkling of the film 210.

In still other example embodiments, the folding guides 240-245 vary from about % inch to about 1 inch in diameter, with a preferred diameter of approximately 11/16 inch. In still further example embodiments, the folding guides 240-245 have uniform diameter throughout their length. As an alternative, according to example embodiments, the portions of the folding guides 240-245 that contact the film 210 have a smaller diameter or narrow to a point to further aid in separating the sections of film 210.

According to example embodiments, the folding guides 240-245 are placed in the slits 270 between sections of the film 210 at a guide distance 280 and a guide angle 290. According to further example embodiments, the guide distance 280 is about ⅔ of the distance between the first idler roll 220 and the second idler roll 230, as measured from the point where the film 210 leaves the first idler roll 220 to the point where the film 210 first contacts the folding guides 240-245. According to still further example embodiments, the guide angle 290 between the film 210 and the folding guides 240-245, measured with the folding guides 240-245 leaning toward the first idler roll 220, varies from 20° to 90°, with a preferred angle of about 45°.

As shown in FIG. 2, according to other example embodiments, the system for folding the edges of the film 210 also comprises a nip roll assembly 260. In other example embodiments, the nip roll assembly 260 comprises two rollers 265 pressed together, and are primarily intended to control the tension of the film 210 as it passes through the slitting assembly and the edge folding apparatus. In still other example embodiments, the nip roll assembly 260 also aids in pressing the folds 250 into the film 210, resulting in flat edge folds. In further example embodiments, if the nip roll assembly 260 is not employed, air entrapment occurs within the edge folds. In certain example embodiments, air entrapment within the edge folds results in a film roll with a different appearance and functionality, much like having bubble wrap on the ends of the roll.

Turning back to FIG. 1, according to example embodiments, the film is oscillated 150 and wound 160 onto film rolls once the film's edges are folded. According to further example embodiments, oscillation efficiently distributes the edge folds onto the film roll. In addition, according to still further example embodiments, air is entrapped between the layers of film as the film is wound onto a film roll, making the film easier to unwind and less susceptible to damage.

In producing a film from molten resins as shown in step 110 in FIG. 1, according to example embodiments, films comprised of resins having constituent elements with higher molecular weights than are conventionally used for stretch films are produced. In other embodiments, the resins with greater molecular weight constituent elements increase the level of orientation in the film as it is formed in step 110.

In still other embodiments, the resins are extruded onto the casting roll through an angled die, which further increases the level of orientation in the film. In certain embodiments, as a result of the increased level of orientation, the film does not have to be stretched in a separate operation. Eliminating the stretching step makes the film simpler, quicker, and less expensive to produce.

According to example embodiments, a cling agent is incorporated into the film to enable an oriented film to be produced without an extensive storage time between steps in the manufacturing process. In further example embodiments, the cling agent does not require an extended period of time to migrate to the surface of the film. As a result, the cling properties of the film will be almost immediately apparent. Eliminating the storage time further reduces the time and cost associated with producing stretch film.

According to example embodiments, the film is comprised of one layer or multiple layers. In further embodiments, the composition of each layer varies.

In further example embodiments, resins used to produce the film layers include, but are not limited to, Ziegler Natta (ZN) catalyzed linear low density polyethylene (ZN-catalyzed LLDPE), metallocene catalyzed linear low density polyethylene (m-LLDPE), polyethylenes, polyethylene copolymers, polyethylene terpolymers, polyethylene blends, polypropylenes, polypropylene copolymers, and blends thereof.

According to certain embodiments, the majority of the ZN-catalyzed LLDPE and m-LLDPE molecules inherently lack long-chain branching.

In further embodiments, the ZN-catalyzed LLDPE resin has a composition breadth index (CDBI), which is defined as the weight percent of the copolymer molecules having a comonomer content within 50 percent of the median total molar comonomer content, of less than 70 percent. In example embodiments, the CDBI of ZN-catalyzed LLDPE resin may range from about 30 percent to about 60 percent.

According to example embodiments, the film is a three-layer film with a majority layer sandwiched between two minority layers. In still other example embodiments, the thickness of the minority layers ranges from about 0 to about 49 percent of the total film thickness. In further embodiments, the preferred thickness of the minority layers is about 16 percent of the total film thickness.

According to example embodiments, the majority layer comprises an LLDPE copolymer resin. In certain embodiments, the LLDPE copolymer resin is a higher alpha-olefin LLDPE resin.

In other example embodiments, the melt index of the LLDPE copolymer resin selected for the majority layer ranges from about 0.5 g/10 min. at 190° C. and 2.16 kg to about 4 g/10 min. at 190° C. and 2.16 kg, with a preferred melt index ranging from about 0.8 g/10 min. at 190° C. and 2.16 kg to about 1.2 g/10 min. at 190° C. and 2.16 kg.

According to further example embodiments, the density of the LLDPE copolymer resin used the majority layer ranges from about 0.900 g/cc to about 0.960 g/cc, with a preferred density of about 0.920 g/cc.

In other example embodiments, using a LLDPE copolymer resin with a higher molecular weight than is conventionally used in stretch films increases the level of orientation when the film is extruded through a die. In still other example embodiments, the LLPDE copolymer resin is also combined with other resins, including, but not limited to, other polyethylenes, polyethylene copolymers, and polypropylene copolymers.

According to certain example embodiments, the minority layers are resins comprised of polyethylene, polyethylene copolymers, polypropylene copolymers, or blends thereof. Depending upon the desired properties of the film, the minority layers have different compositions, according to example embodiments. In further example embodiments, the melt index of the resins selected for the minority layers range from about 0.5 g/10 min. at 190° C. and 2.16 kg to 12 g/10 min. at 190° C. and 2.16 kg, with a preferred melt index ranging from about 3 g/10 min. at 190° C. and 2.16 kg to 5 g/10 min. at 190° C. and 2.16 kg.

In still further example embodiments, the density of the resins selected for the minority layers range from about 0.850 g/cc to about 0.969 g/cc, with a preferred density of about 0.917 g/cc.

According to example embodiments, to impart cling to the film, a cling agent is incorporated into the film. In still further example embodiments, cling agents are used as discrete layers. In other example embodiments, cling agents are used as additives in blends of resins for layer(s) of the film.

Depending on the desire properties of the resultant film, embodiments are one-sided, differential, or two-sided cling structures.

In certain example embodiments, such cling agents are migratory. In other embodiments, the cling agents are non-migratory.

In certain example embodiments, a migratory cling agent is metered into a three-layer film through at least one extruder for the minority layers.

In other example embodiments wherein the film comprises a single layer, a migratory cling agent is metered into the film through the extruder for that layer.

In further example embodiments, the rate at which the migratory cling agent is metered into the film ranges from about 0 percent to about 25 percent of the total film structure on a weight-to-weight basis, with a preferred rate of about 0.6 percent of the total film structure on a weight-by-weight basis.

In alternative example embodiments, a non-migratory cling agent is added to the minority layers at a rate of about 0 percent to about 25 percent of the total film structure on a weight-to-weight basis, with a preferred rate of about 1 percent of the total film structure on a weight-to-weight basis.

According to example embodiments, a polybutene polymer with a Saybolt Universal Viscosity of 14,900 SUS at 99° C. with an average molecular weight of 2,060 is used as a cling agent. In further example embodiments, the molecular weight of this cling agent is higher than the molecular weight of a cling agent typically used in stretch films (which is polybutene with a Saybolt Universal Viscosity of 3,000 SUS at 99° C. with an average molecular weight of 1,290).

In still further example embodiments, unlike the typical cling agent, the higher molecular weight polybutene polymer will not require time to migrate to the film's surface.

In additional example embodiments, the higher molecular weight polybutene polymer is minimally affected over time or winding tension. In certain example embodiments, the oriented film is produced in-process, which is more cost-effective and efficient than the standard practice of producing master rolls of film, storing the master rolls for several days while the cling develops, and then converting the master rolls into pre-stretched film.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions are also made without departing from the spirit or scope thereof.

1. An apparatus for producing folded edges in a film in-process, the apparatus comprising:
a first idler roll;
a second idler roll separated from the first idler roll by a first distance; and
a plurality of folding guides that are positioned between the first idler roll and the second idler roll, wherein each folding guide separates adjacent sections of film and induces two folds, thereby causing an edge of each section of film to turn under 180° and cling to a bottom surface of the section of the film, as the film travels from the folding guides to the second idler roll;
wherein the film comprises a majority layer comprising a Ziegler Natta catalyzed linear low density polyethylene (LLDPE) copolymer resin having molecules that inherently lack long chain branching, wherein a majority of said molecules are oriented in a substantially longitudinal direction due to an induced strain.

2. The apparatus of claim 1, the film further comprising LLDPE copolymer resin blended with other resins chosen from the group consisting of Ziegler Natta catalyzed LLDPE, metallocene catalyzed linear low density polyethylene (m-LLDPE), polyethylenes, polyethylene copolymers, polyethylene terpolymers, polyethylene blends, polypropylenes, polypropylene copolymers, and blends thereof.

3. The apparatus of claim 1, the film further comprising a plurality of minority layers and a total film thickness.

4. The apparatus of claim 3, further wherein the minority layers comprise resins chosen from the group consisting of Ziegler Natta catalyzed LLDPE, metallocene catalyzed linear low density polyethylene (m-LLDPE), polyethylenes, polyethylene copolymers, polyethylene terpolymers, polyethylene blends, polypropylenes, polypropylene copolymers, and blends thereof.

5. The apparatus of claim 3, wherein the minority layers have a thickness ranging from about 0 to about 49 percent of the total film thickness.

6. The apparatus of claim 5, wherein the minority layers have a thickness of about 16 percent of the total film thickness.

7. The apparatus of claim 4, further wherein the resins comprising the minority layers have a melt index ranging from about 0.5 g/10 min. @ 190° C./2.16 kg to about 12 g/10 min. @ 190° C./2.16 kg.

8. The apparatus of claim 7, further wherein the resins comprising the minority layers have a melt index ranging from about 3 g/10 min. @ 190° C./2.16 kg to about 5 g/10 min. @ 190° C./2.16 kg.

9. The apparatus of claim 4, further wherein the resins comprising the minority layers have a density ranging from about 0.850 g/cm³ to about 0.969 g/cm³.

10. The apparatus of claim 9, further wherein the resins comprising the minority layers have a density of about 0.917 g/cm³.

11. The apparatus of claim 1, further wherein the majority layer comprises a higher density alpha-olefin LLDPE resin.

12. The apparatus of claim 1, further wherein the resin comprising the majority layer has a melt index ranging from about 0.5 g/10 min. @ 190° C. 12.16 kg to about 4 g/10 min. @ 190° C./2.16 kg.

13. The apparatus of claim 12, further wherein the resin comprising the majority layer has a melt index ranging from about 0.8 g/10 min. @ 190° C./2.16 kg to about 1.2 g/10 min. @ 190° C./2.16 kg.

14. The apparatus of claim 1, further wherein the resin comprising the majority layer has a density ranging from about 0.900 g/cm³ to about 0.960 g/cm³.

15. The apparatus of claim 14, further wherein the resin comprising the majority layer has a density of about 0.920 g/cm³.

16. The apparatus of claim 1, further wherein the Ziegler Natta catalyzed LLDPE copolymer resin has a composition depth breadth index of about less than 70 percent.

17. The apparatus of claim 16, further wherein the Ziegler Natta catalyzed LLDPE copolymer resin has a composition depth breadth index of about 30 percent to about 60 percent.

18. The apparatus of claim 1, further wherein at least 20 percent of the majority layer comprises the Ziegler Natta catalyzed LLDPE copolymer resin having molecules that inherently lack long chain branching.

19. A method of folding edges of film in-process, said method comprising:
separating a first idler roll and a second idler roll by a first distance;
positioning a plurality of folding guides between the first idler roll and the second idler roll;
separating adjacent sections of film comprising a majority layer comprising a Ziegler Natta catalyzed linear low density polyethylene (LLDPE) copolymer resin having molecules that inherently lack long chain branching, wherein a majority of said molecules are oriented in a substantially longitudinal direction due to an induced strain, and inducing two folds in the film with each folding guide, thereby causing an edge of each section of film to turn under 180° and cling to a bottom surface of the section of film; and
moving the adjacent sections of film from the folding guides to the second idler roll.

20. The method of claim 19, the film further comprising LLDPE copolymer resin blended with other resins chosen from the group consisting of Ziegler Natta catalyzed LLDPE, metallocene catalyzed linear low density polyethylene (m-LLDPE), polyethylenes, polyethylene copolymers, polyethylene terpolymers, polyethylene blends, polypropylenes, polypropylene copolymers, and blends thereof.

21. The method of claim 19, the film further comprising a plurality of minority layers and a total film thickness.

22. The method of claim 21, further wherein the minority layers comprise resins chosen from the group consisting of Ziegler Natta catalyzed LLDPE, metallocene catalyzed linear low density polyethylene (m-LLDPE), polyethylenes, polyethylene copolymers, polyethylene terpolymers, polyethylene blends, polypropylenes, polypropylene copolymers, and blends thereof.

23. The method of claim 21, wherein the minority layers have a thickness ranging from about 0 to about 49 percent of the total film thickness.

24. The method of claim 23, wherein the minority layers have a thickness of about 16 percent of the total film thickness.

25. The method of claim 22, further wherein the resins comprising the minority layers have a melt index ranging from about 0.5 g/10 min. @ 190° C./2.16 kg to about 12 g/10 min. @ 190° C./2.16 kg.

26. The method of claim 25, further wherein the resins comprising the minority layers have a melt index ranging from about 3 g/10 min. @ 190° C./2.16 kg to about 5 g/10 min. @ 190° C./2.16 kg.

27. The method of claim 22, further wherein the resins comprising the minority layers have a density ranging from about 0.850 g/cm³ to about 0.969 g/cm³.

28. The method of claim 27, further wherein the resins comprising the minority layers have a density of about 0.917 g/cm³.

29. The method of claim 19, further wherein the majority layer comprises a higher density alpha-olefin LLDPE resin.

30. The method of claim 19, further wherein the resin comprising the majority layer has a melt index ranging from about 0.5 g/10 min. @ 190° C.12.16 kg to about 4 g/10 min. @ 190° C./2.16 kg.

31. The method of claim 30, further wherein the resin comprising the majority layer has a melt index ranging from about 0.8 g/10 min. @ 190° C./2.16 kg to about 1.2 g/10 min. @ to 190° C./2.16 kg.

32. The method of claim 19, further wherein the resin comprising the majority layer has a density ranging from about 0.900 g/cm³ to about 0.960 g/cm³.

33. The method of claim 32, further wherein the resin comprising the majority layer has a density of about 0.920 g/cm³.

34. The method of claim 19, further wherein the Ziegler Natta catalyzed LLDPE copolymer resin has a composition depth breadth index of about less than 70 percent.

35. The method of claim 34, further wherein the Ziegler Natta catalyzed LLDPE copolymer resin has a composition depth breadth index of about 30 percent to about 60 percent.

36. The method of claim 19, further wherein at least 20 percent of the majority layer comprises the Ziegler Natta catalyzed LLDPE copolymer resin having molecules that inherently lack long chain branching.
